(19) United States
(12) Patent Application Publication
(10) Pub. No.: US 2012/0109980 A1
(43) Pub. Date: May 3, 2012

(54) METHOD FOR RETRIEVING, ORGANIZING AND DELIVERING INFORMATION AND CONTENT BASED ON COMMUNITY CONSUMPTION OF INFORMATION AND CONTENT.

(76) Inventors: Brett Strauss, Dallas, TX (US); Himansu Karunadasa, Dallas, TX (US)

(21) Appl. No.: 13/287,118

(22) Filed: Nov. 1, 2011

Related U.S. Application Data
(60) Provisional application No. 61/408,894, filed on Nov. 1, 2010.

(51) Int. Cl. G06F 17/30

(52) U.S. Cl. 707/751; 707/E17.014

(57) ABSTRACT

A method and system for designing a knowledge portal for retrieving, organizing and delivering information and content to portal users, wherein the information and content viewed, modified or accessed by each user has been analyzed, compared, rated, ranked or tagged against the user's profile, prior content consumption, other user profiles and by consumption of similar information and content within the community of portal users. The method and system further comprises a process by which users can upload, create or modify information and content within the portal, and thereafter rate, review and tag said information and content for sharing within the community of portal users to influence the content delivered to the user as well as the community of portal users and subsequently construct and influence the knowledge portal in accordance with community patterns. The knowledge portal evolves to reflect the desires and preferred content of the community of users.

### CROSS-REFERENCE TO RELATED APPLICATIONS

Provisional Application: U.S. Patent Application No. 61/408,894 filed Nov. 1, 2010, and entitled “METHOD FOR RETRIEVING, ORGANIZING AND DELIVERING INFORMATION AND CONTENT BASED ON COMMUNITY CONSUMPTION OF INFORMATION AND CONTENT.”

### TECHNICAL FIELD

The present invention relates to the design of a content recommendation engine comprising, in part, a portal database and system, which serves information and content to a community of users, wherein the content recommendation engine retrieves, analyzes, organizes and delivers information based on community consumption of information and content.

### BACKGROUND

Like an organization, a community can maintain vast stores of information and content provided by users within the community, such information and content may be very relevant to one user, some users, or all users; however, unlike an organization, there are no duties or specific goals or objectives the community has to achieve. Although community information may, like an organization, include different forms of public and private data developed within the community, the knowledge and experience of the community users, and public and private data originating outside the community, community information may also have no specific goal directing what the community must achieve. Community information portals often have no business purpose or objective; but, rather, a free flow of information and content based on individual user rating, tagging, and rating against other user profiles or user consumption of similar information and content as a whole within the community of users, as compared against user profiles. Unlike an organization, no specific knowledge of the community is critical to achieving a business objective, but rather each community member is free to choose their own objectives based on information and content consumption of their own choosing. For instance, when a community member changes his or her profile then the information and content retrieved, organized and delivered to that user changes as well. Further, as a user consumes information and content that too will affect the information and content retrieved, organized and delivered. The present invention designs a recommendation engine which will analyze the consumption habits of individual users and compare them with like users thereby providing relevant information and content to those users for individual consumption.

Unlike the rigidity of organizational clustering, such as sales, engineering and manufacturing, whose members share a common base of knowledge, tools and processes; ways of conceptualizing or organizing that knowledge, the present invention is driven not solely by user classification (typically a user profile) but by actual information and content consumed by users, such user and content depositing a referential marker upon each other thereby creating a consumption index consisting of two parts: an indexed reference to what content a user has consumed; and an indexed reference to who is consuming the content. Such indexed references can be stored either in a user profile, content profile, or referentially linked though pointers in a computer database. There is no bright line rule as to what portal users will utilize and there is no restriction on user groupings within the portal. User groupings will be natural, dynamic and, for the most part, unanticipated because it arises from content consumption of like-minded users; consumed content will involve a hierarchy of categories and subcategories based on aggregated user consumption of content with little or no inquiry into a user defined profile or pre-defined content profiles.

Oftentimes knowledge databases and knowledge portals are rigid and classify a user into artificial groups which drive information and content consumption. These traditional knowledge databases filter user information and content based on what the organization has defined as the user's “role” as compared to the information and content actually consumed by the individual user. This often leads to user dissatisfaction with the information and content received. The traditional search based on keywords simply does not work in all cases. While the present invention does allow users to create profiles which are suggestive of the type of information and content they like to receive, the actual information and content consumption of the individual user, and the consumption of users with similar profiles, ultimately determines what the present invention will or will not retrieve, analyze, organize and deliver to said user.

As used herein, the present invention is a recommendation engine computer-based tool, an internet and/or intranet hosted computer-based tool, that provides knowledge search and retrieval capability to individual users based on user content consumption resulting in a more satisfactory computing experience. In short, the present system is adaptive to the behavior of the individual as well as the overall user community content consumption behaviors. The knowledge portal is built initially in part by user preferences established by the user, and optionally content preference established by an organization, but then the recommendation engine creates pattern preferences based on user consumption of information and content, both individual and aggregate. Like a swarm mentality, the knowledge portal of the present invention evolves as consumption changes. The present invention will also suggest that users enhance their individual profiles as their consumption habits change. In some cases, if the user allows, the present invention will automatically adjust their profile to conform to the user's then current information and content consumption habits. The recommendation engine is a knowledge portal without the rigidity of traditional knowledge portals.

Traditional content delivery is primarily done by the users' search for materials which are predefined by an organization. See FIG. 10. In FIG. 10, the traditional process is outlined in that users of an organization will search for materials and receive results based on those searches. Whereas FIG. 11 shows the content consumption model of the present invention in that what a user has consumed drives what he has accessed. This consumption results in a user profile being, in part, derived from content consumption. See FIG. 12; FIG. 13; FIG. 14; FIG. 15

Still other objects and advantages of the invention will be obvious and apparent from the specification.

### SUMMARY OF THE INVENTION

The present disclosure, a content recommendation engine, is a method for retrieving, organizing, and delivering information and content based on community consumption of information and content. The collection of information from an online community of users involves an informal organization or group of users characterized by a common interest. This informal group is not organized based on business processes but rather based on consumption of content. In the present embodiment, consumed content may consist of documents, databases, peripherals, web sites, or tools accessible via local area network (LAN), the organization's intranet, the external Internet, or other electronic means. The user's consumed content is assigned a consumption index, which is stored and associated with the user's self-generated profile or, optionally referentially linked though pointers in a computer database, for association with the user. For example, FIG. 1, shows a record layout which consists of a user profile (FIG. 1.5), the user profile includes a relational record link: a consumption index identifying the content which has been accessed and reviewed by a user (eg. consumed content). Optionally, a minimum of user corporate preferences can be provided to further distinguish a user within a corporate environment; however, such optional corporate preferences are not a prerequisite to the present invention (FIG. 1.2). The relational record link (FIG. 1.7) consists of a retained and stored user consumption index. Likewise, a peripheral device such as a computer, printer or other IP enabled network device, with a profile of its own can include an relational record link, its own content consumption index identifying the users who have accessed the peripheral device (FIG. 2.20; 2.22), including a content consumption index identifying the content which has been printed on such device (FIG. 11). Similarly, consumed content, may have a profile of its own which can include relational record links, its content consumption index identifying the users who have accessed the consumed content (FIG. 3.30), including a consumption index identifying the peripheral to which such content has been delivered (FIG. 3.30). An analogy to summarize parts of the present invention is that the informational content one consumes becomes a part of your online genetic make-up, an electronic finger print of sorts (FIG. 14). FIG. 15 is a graphical example of how the identity of a user of the present invention becomes defused by those pieces of the on-line environment which such user consumes. Consumption means to access, view, display, print or otherwise interact with content and users within the on-line environment.

Aggregated and individual user consumed content is analyzed through a Bayesian calculation to identify and rank specific content and common interests and stored in database for use by the present disclosure, a content recommendation engine. A Bayesian probability equation to enhance the suggestions that the invention provides to users based on probability patterns found in consumption habits. In probability theory and applications, Bayes' theorem (alternatively Bayes' law or Bayes' rule) links a conditional probability to its inverse. That is, it provides the relationship between P(A|B) and P(B|A). It is valid in all common interpretations of probability, and is commonly used in science and engineering. Probability measures the proportion of trials in which an event occurs. On this view, Bayes' theorem is a general relationship between P(A), P(B), P(A|B) and P(B|A) for any events A and B in the same event space. Under the Bayesian interpretation of probability, probability, or uncertainty, measures confidence that something is true. On this view, Bayes' theorem links the uncertainty of a probability model before and after observing the modeled system. For example, a probability model, A, is hypothesized to represent a die with an unknown bias. The die is thrown a number of times to collect evidence, B. P(A), the prior, is the initial uncertainty in the model. P(A|B), the posterior, is the uncertainty in the model having accounted for whether the evidence supports or refutes the model. P(B|A)/P(B) represents the degree of support B provides for A. Thereafter, the content recommendation engine reflects the patterns of use such that the user is automatically displayed relevant content as determined by the content recommendation engine given each user's then current content consumption habits. This combination of data analysis allows the present invention to further predict additional content for the individual user based on the user's profile and content consumption, as well as the community users' profiles and content consumption. In addition, the user also has the option of altering their profile to increase the usefulness of recommended data. By using a Bayesian probability equation, the present invention can quantify a users relationship to other users and content based on common consumed content, such quantification can be used to better predicatively deliver relevant content to users. See FIG. 16.

In the present embodiment, the recommendation engine can include organizing data into a hierarchy of categories and subcategories based on aggregated user consumption. The patterns of user consumed content is periodically reanalyzed, updated and stored within the content portal database to keep the information as up to date as possible. As the user's preferences, content consumption and profile change, the analysis of that information changes as does the content in the database. The patterns of user consumed content are periodically aggregated before being reanalyzed, updated and stored within the content portal database to keep the information as up to date as possible. The aggregation serves to provide a more complete representation of user content consumption by collecting an aggregate sample of the population. As the users' preferences, content consumption and profiles change, the analysis of that information changes as does the content in the database. As user consumption of content evolved through a users access of content, the present invention statistically weights the relevance of potential new content to be delivered to a user based on the frequency in which a user consumes like content. For instance, the more frequent a specific type of content is consumed by the user, the more relevant it becomes over time.

An object of the present invention is to present content to a user based on the combination of the user's self-generated profile, the user's information and content consumption, and the information and content consumption of other community users with similar profiles and content consumption habits. The combination of these factors will ensure that the content retrieved, organized, and delivered by the present invention is specifically tailored to each individual's desires for a more satisfactory informational experience. It is an additional object of the present invention to evolve as consumption habits of the community users change. Further, the invention will suggest that individual users update their profiles as that user's consumption habits change so that the invention continues to provide relevant information and content. With the permission of the user, the invention is also capable of automatically adjusting user profiles to reflect the most current information and content consumption.

The present invention also allows a user to rate, rank and tag such user's prior consumed content to aid the recommendation engine in selecting relevant consumed content to offer to other portal users of like content consumption habits. Optionally, the present invention further comprises a process by which users can upload, create or modify information and content for analyzes by the recommendation engine, and thereafter rate, review and tag such uploaded, created or modified information and content for sharing to other portal users of like content consumption habits, as determined by the recommendation engine.

With the above and other objects in view, the present invention resides in the novel features of form, construction, arrangement and combination of parts presently described and pointed out in the specification.

### BRIEF DESCRIPTION OF THE DRAWINGS

FIG. 1 is a diagram representing the human “digital” DNA system

FIG. 2 is a diagram representing the machine “digital” DNA system

FIG. 3 is a diagram representing the data “digital” DNA system

FIG. 4 is a diagram representing the digital data links system

FIG. 5 is a diagram representing how the hardware output is determined

FIG. 6 is a diagram representing the content recommendation engine

FIG. 7 is a diagram representing the Bayesian Calculation algorithm and the results as relevant data with rankings

FIG. 8 is a diagram representing a technique for retrieving relevant resources from external data repositories.

FIG. 9 is a diagram representing the asset user profile

FIG. 10 depicts traditional website or portal sharing search results altered by comparison to search results of the community of users

FIG. 11 depicts social content relationship management as developed by the present invention

FIG. 12 is a diagram representing the asset profile composed of information from the primary profile, user controlled profile and the controlled profile

FIG. 13 is a diagram representing the exchange of information between the user profile and the asset profile

FIG. 14 is a diagram representing the user asset profile as influenced by the community consumption of content

FIG. 15 is a diagram representing the user profile identity as influenced by the user's profile and the content profile of the community users

FIG. 16 is a diagram representing social content relationship mapping which determines by Bayesian calculations which content is most appealing to the individual user

### DETAILED DESCRIPTION OF DRAWINGS

Referring now to the drawings, the various views and embodiments of the present disclosure are illustrated and described. The drawings have been exaggerated and/or simplified in places for illustrative purposes only. One of ordinary skill in the art will appreciate the many possible applications and variations.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modification, changes, rearrangements, substitutions, alternative, design choices, and embodiments.

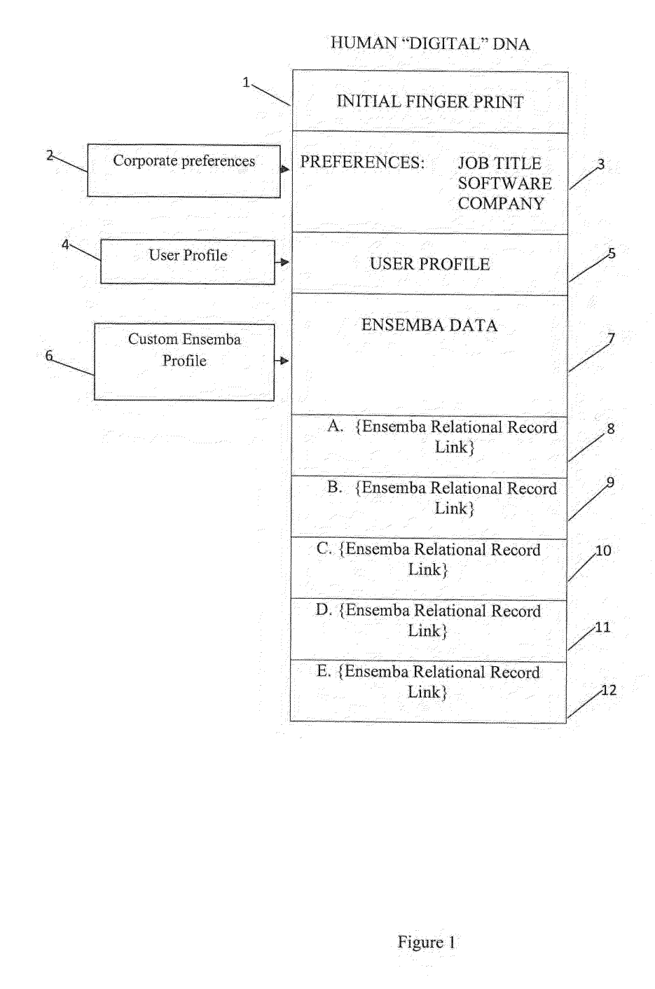

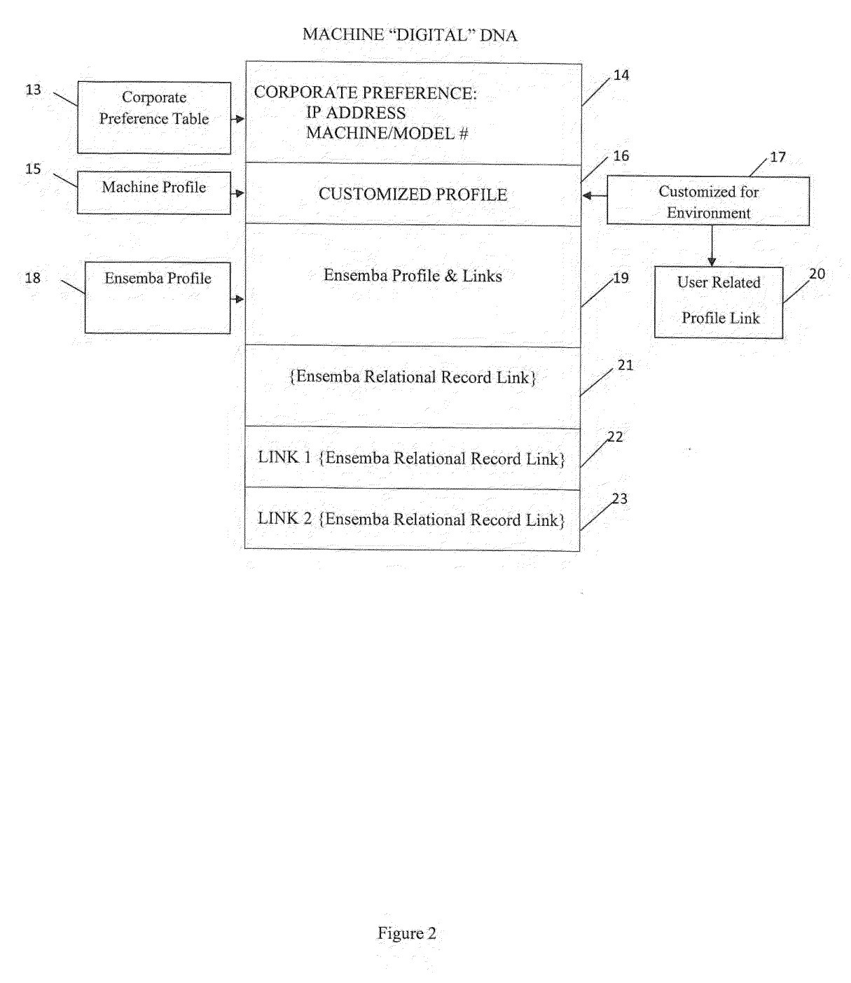

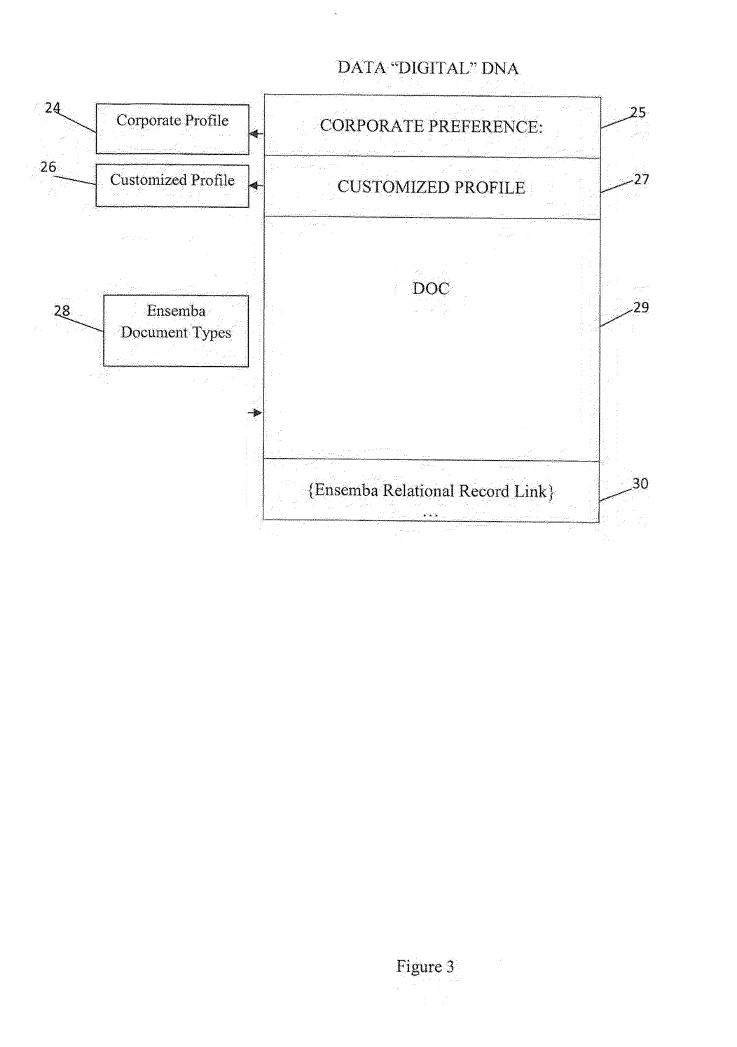

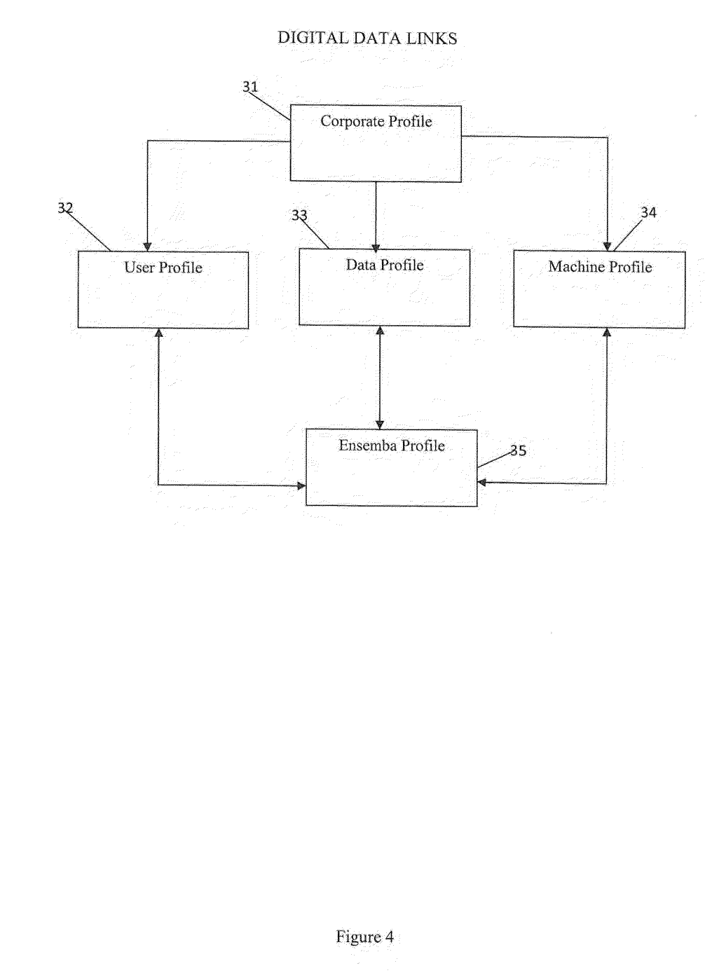

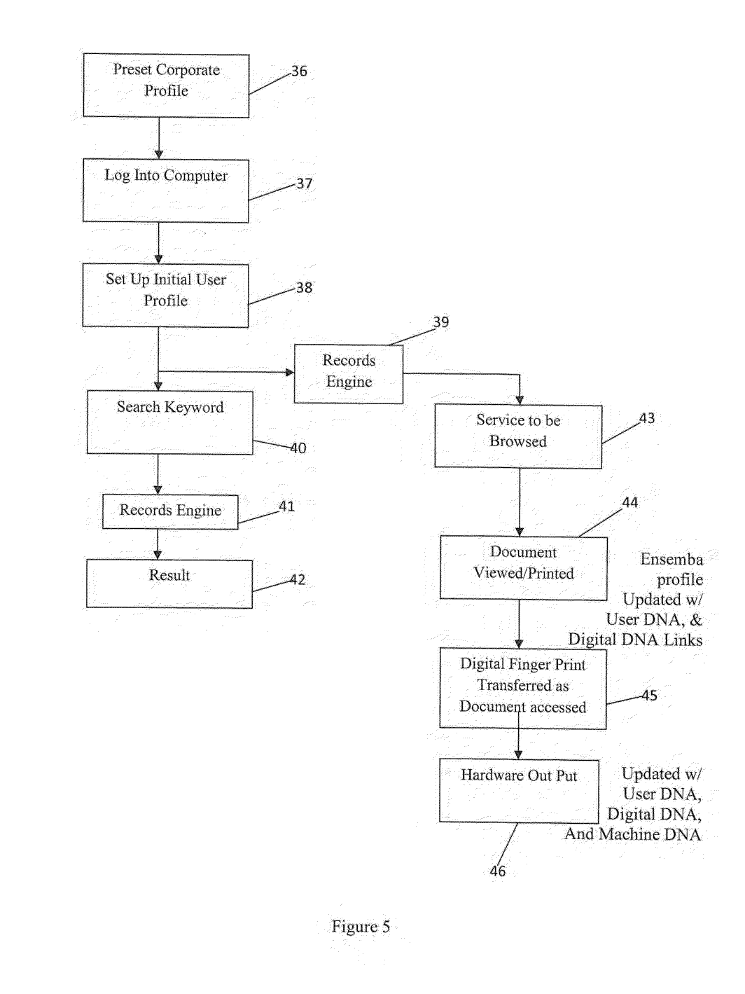

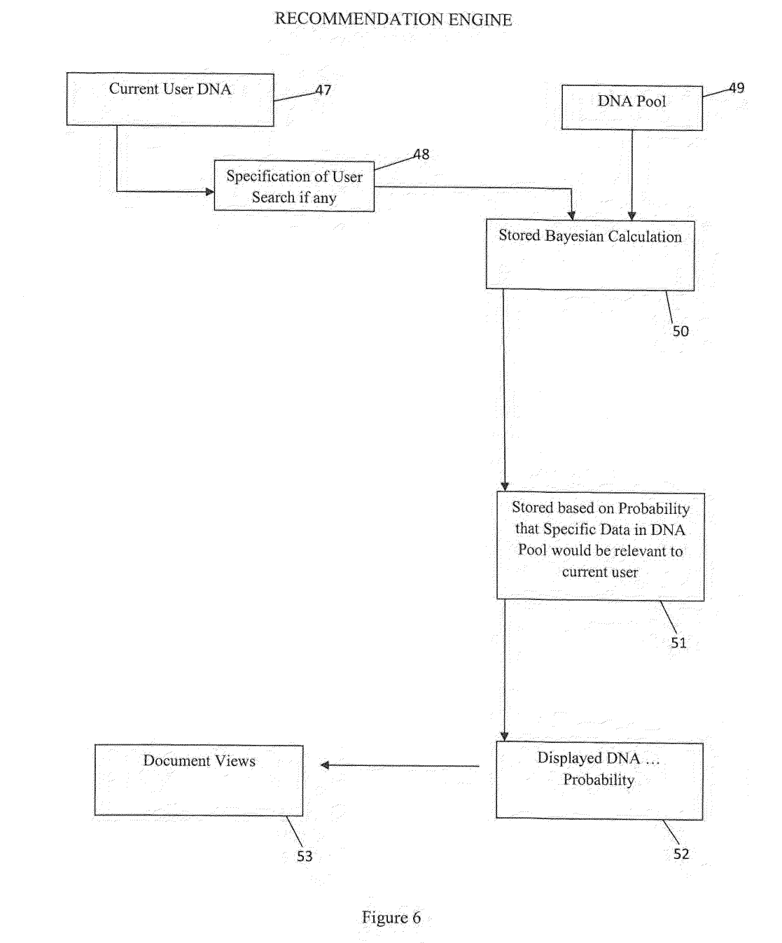

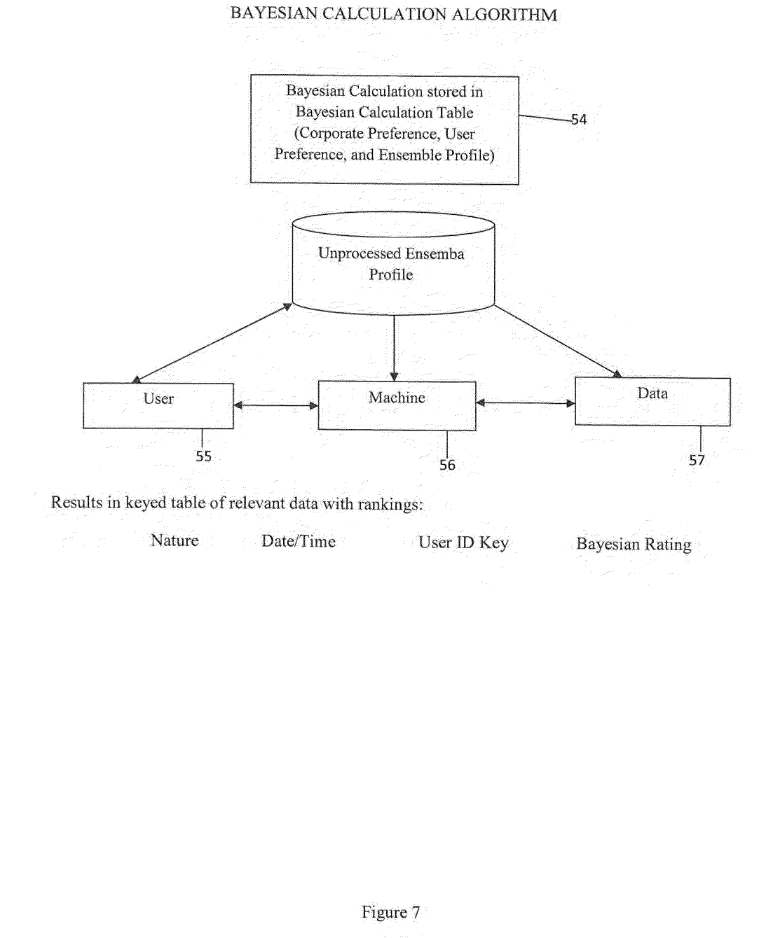

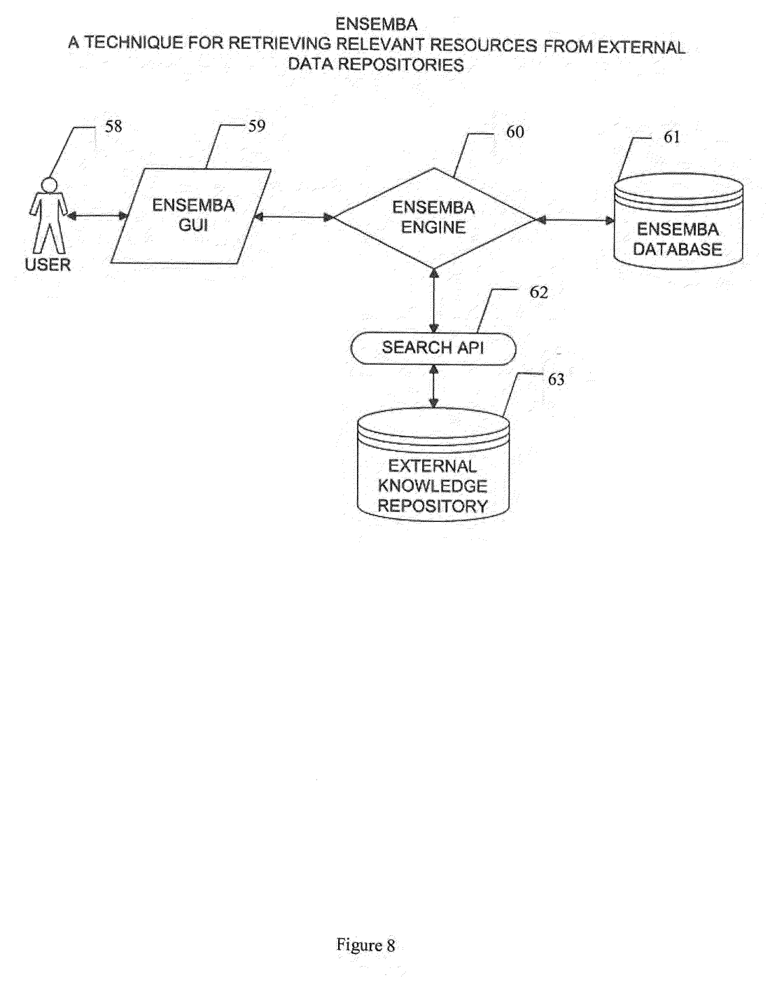

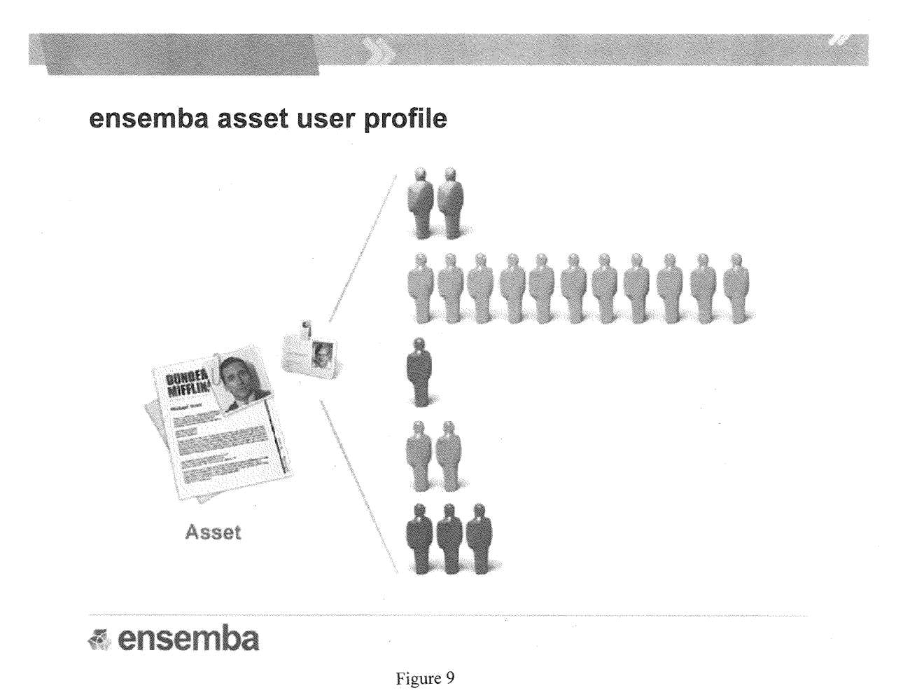

With reference to FIG. 1, this view is the human “digital” DNA, which is a representation of the user's patterns of use based on the content viewed. The initial fingerprint (FIG. 1.1) FIG. 2 is the machine “digital” DNA, which is a representation of the composition of the present disclosure. FIG. 3 is the data “digital” DNA, which is a representation of the composition of data and content consumed by the user. FIG. 4 illustrates the relational links between the various types of data utilized by the present disclosure. FIG. 5 represents the chain of events involved in producing the output from the user setting up a profile (FIG. 5.36), to searching the records engine (FIG. 5.41) through keywords (FIG. 5.40). The records engine (FIG. 5.39) also browses the internet and produces documents viewed or printed (FIG. 5.44) by the user, which are now marked with a digital fingerprint (FIG. 5.45) and can be output through the hardware (FIG. 5.46). FIG. 6 is the recommendation engine that compares the user's information to the community users' information to produce preferred content for the user. FIG. 7 is a representation of the Bayesian calculation algorithm used to identify and rank specific content and common interests associated with an individual user. FIG. 8 is a representation of how Ensemba retrieves relevant resources from external data repositories. FIG. 9 represents the Ensemba asset user profile which is influenced by the content consumption of the community of users.

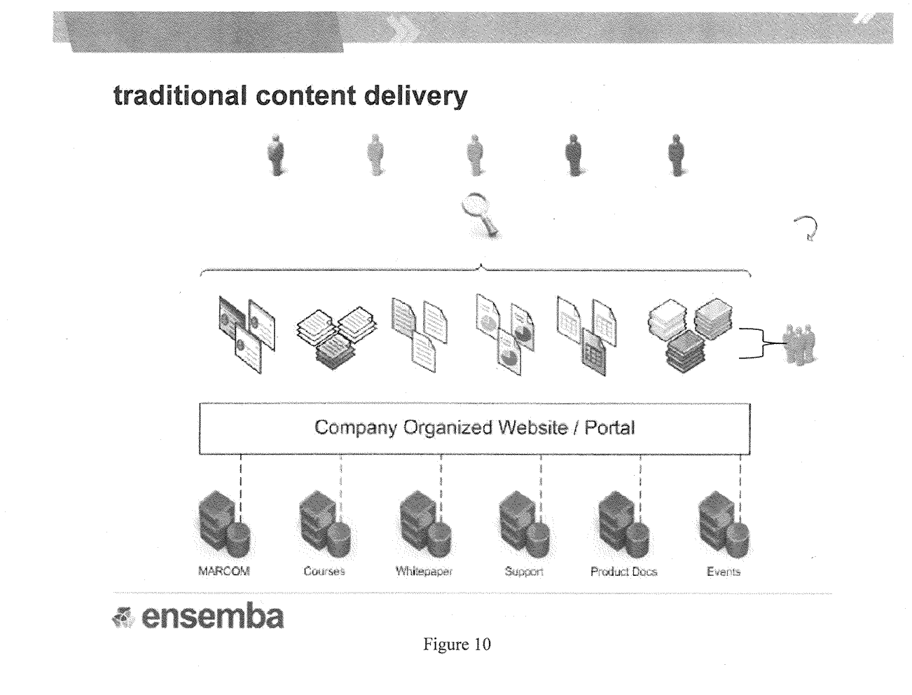

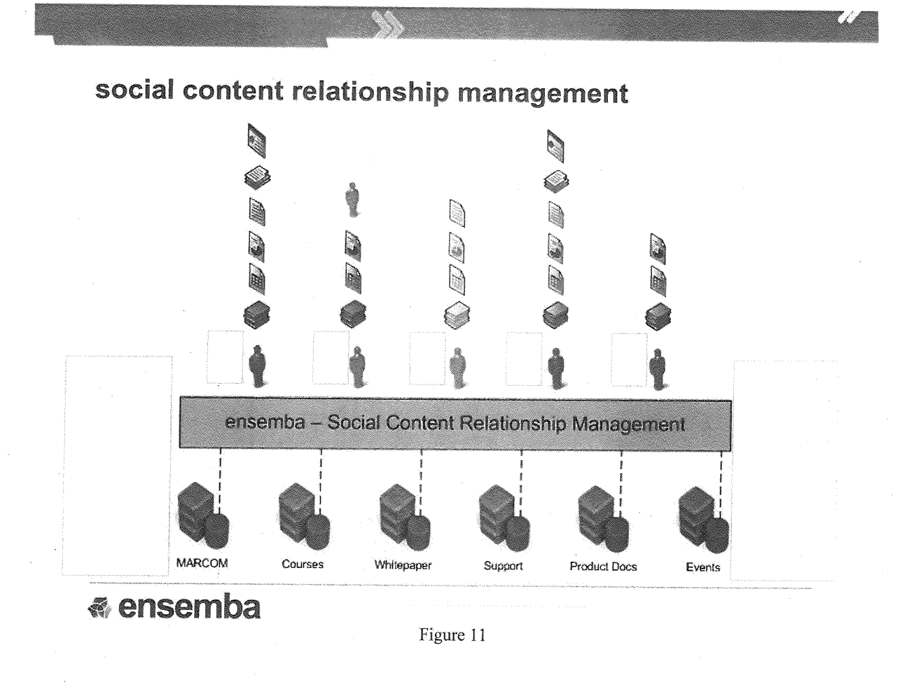

FIG. 10 depicts traditional website or portal sharing individual user search results altered by comparison to search results of the community of users. FIG. 11 depicts social content relationship management as developed by the present invention. FIG. 11 shows the organization and analysis of the data using a Bayesian calculation to identify and rank specific content and common interests amongst the users.

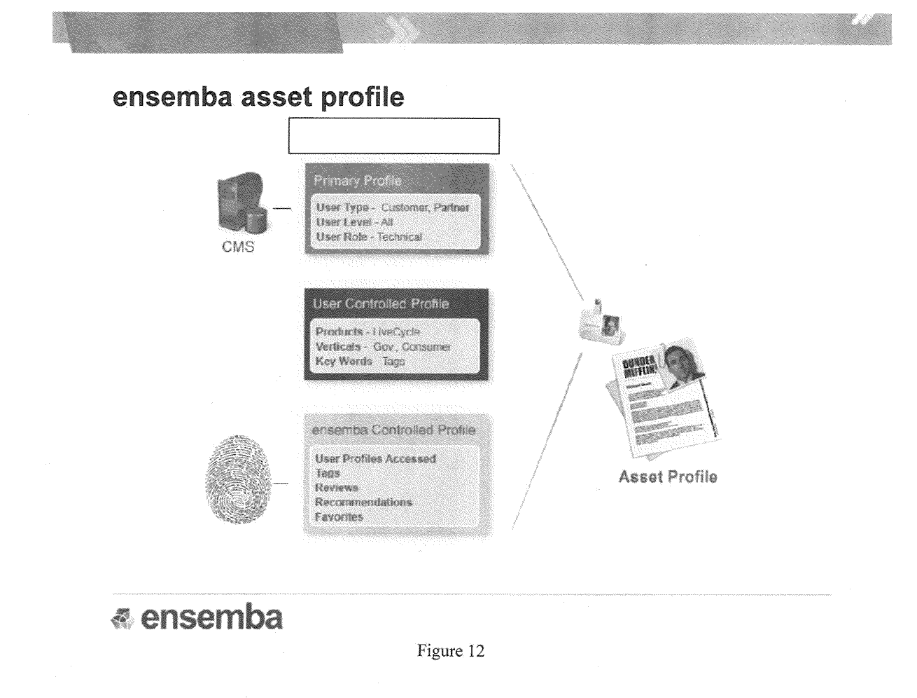

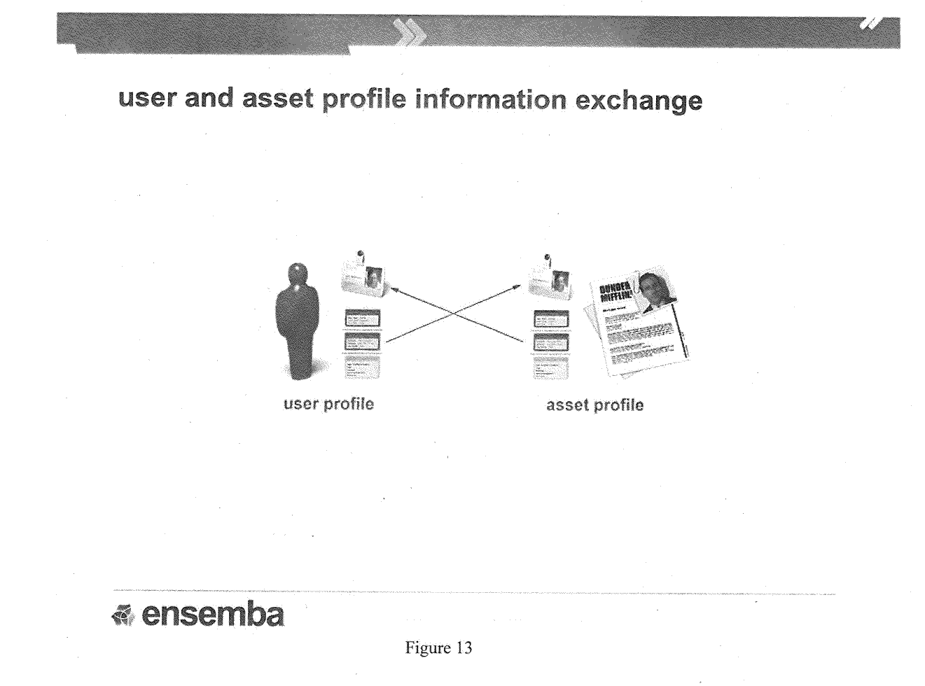

FIG. 12 is a diagram representing the asset profile composed of information from the primary profile, user controlled profile and the referentially linked controlled profile establishing the consumption index. The user controlled profile is based on the information submitted by the user. The Ensemba controlled profile is based on the calculation of what content would appeal to the user after comparing the user's content consumption to the content consumption of the online community. FIG. 13 represents the exchange of information between the user profile and the asset profile, which serves to maintain the most accurate and up to date information in the asset profile. This exchange serves to ensure that the user is receiving recommendations for the most relevant content for consumption.

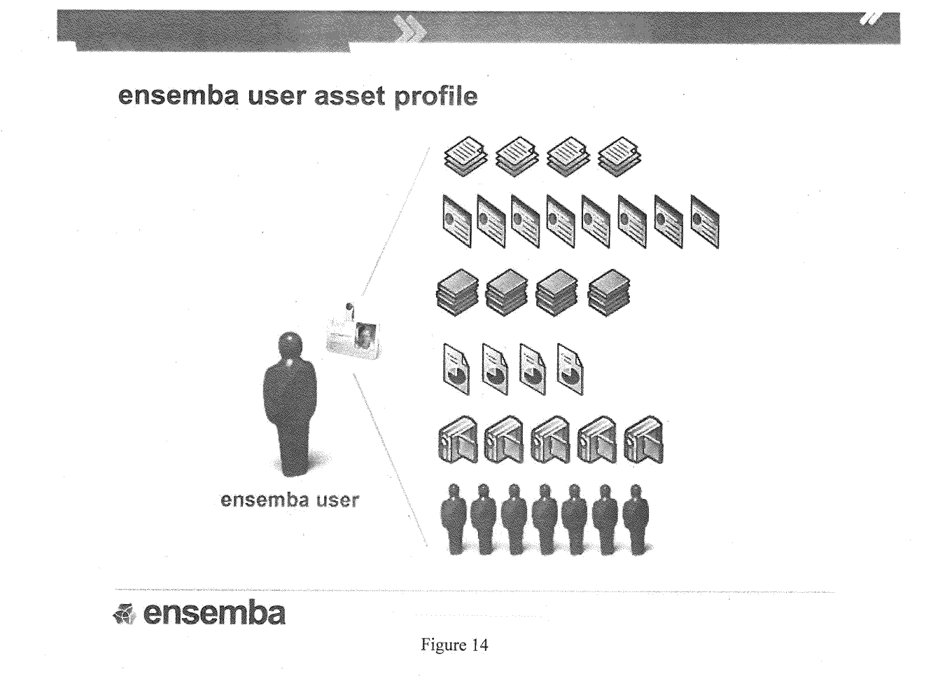

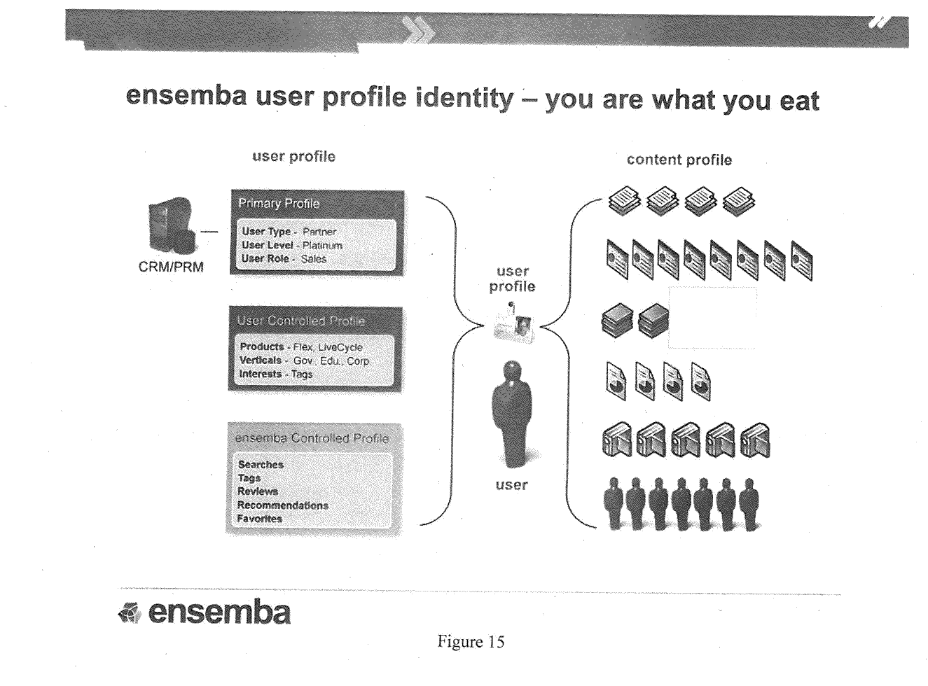

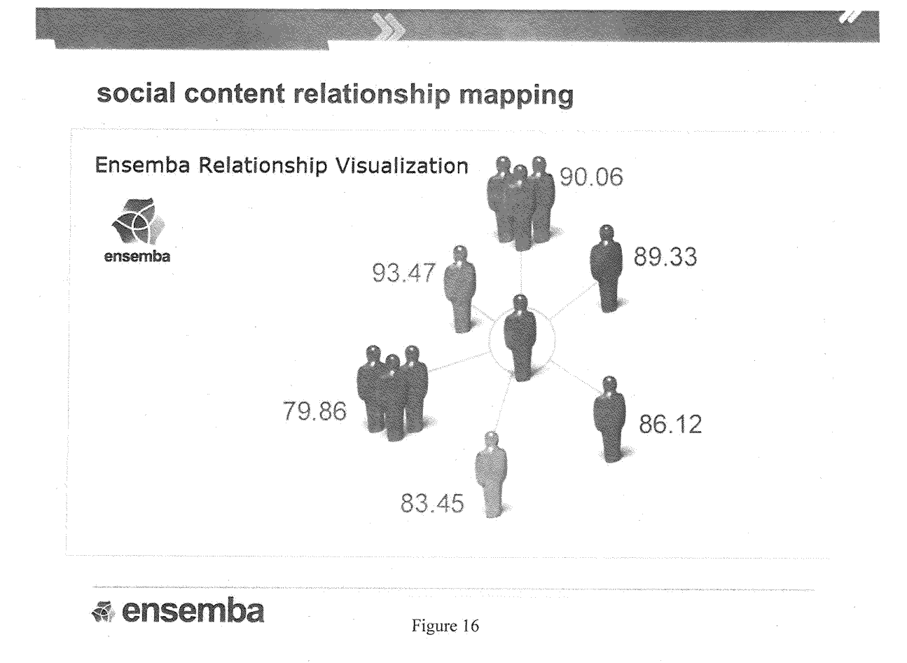

FIG. 14 represents a user profile as influenced by the community consumption of content. The profile is related to the hardware aspect of this disclosure. FIG. 15 represents the user profile identity as influenced by the user's profile and the content profile of the community users. The user profile is composed of self-identifying information entered by the user. The present disclosure offers the user the opportunity to update the user profile information. The content profile stores an indexed reference to who is consuming the content. FIG. 16 represents social content relationship mapping which determines by Bayesian calculations which content is most appealing to the individual user based on consumed content of the user and the community.

What is claimed is:

1. A method of designing a content recommendation engine for retrieving, organizing and delivering content to users belonging to an organization or group, the method comprising identifying a community of users belonging to the organization or group characterized by a common interest with respect to each users consumption of content without regard to defined organizational business processes; analyzing patterns of said user consumed content through a Bayesian calculation to identify and rank specific content and common interests associated with said user consumption of content, storing said Bayesian calculation identifying and ranking specific content and common interests associated with said user consumption of content in a database for use by said content recommendation engine, and constructing a content portal in accordance with said patterns such that said user is automatically displayed relevant data as determined by the recommendation engine given each users then current content consumption habits.

2. The method of claim 1 wherein analyzing patterns of user consumed content is periodically reanalyzed, updated and stored within said database for use by said content recommendation engine.

3. The method of claim 1 wherein analyzing patterns of user consumed content is periodically aggregated with other users, reanalyzed, updated and stored within said database for use by said content recommendation engine.

4. The method of claim 1 wherein said consumed content is selected from the group consisting of documents, databases, peripherals, web sites, or tools accessible via local area network (LAN), the organization's intranet, the external Internet, or other electronic means.

5. The method of claim 1 wherein said content recommendation engine organizes data into a hierarchy of categories and subcategories based on aggregated user consumption of content.

6. The method of claim 5 wherein the hierarchy of categories and subcategories includes user, user location, peripheral, peripheral location, type of consumed content, consumed content location, consumed content creating date, consumed content publication date, date of last access of consumed content, web site, headlines, industry, or technology.

7. The method of claim 4 wherein said consumed content is assigned a consumption index based on said Bayesian calculation for association with said user, consumption index stored in and associated with a user profile; and said user is assigned a consumption index based on said Bayesian calculation for association with said consumed content, said consumption index stored in and associated with a consumed content profile.

8. The method of claim 7 wherein analyzing patterns of user consumed content is periodically aggregated with other users, reanalyzed, updated and compared with said consumption index of other user profiles for the purpose of distributing similarly consumed content based on said content recommendation engine.

9. The method of claim 7 wherein analyzing patterns of user consumed content is periodically aggregated with other users, reanalyzed, updated and compared with aggregated user profiles for the purpose of distributing similarly consumed content based on the similarity of said user profiles in said content recommendation engine.

10. The method of claim 9 wherein said user profile includes user name, user location, user age, user experience level, user gender, and a series of consumption indices associated with user consumed content.

11. The method of claim 7 wherein said consumed content profile includes content name, content location, type of consumed content, consumed content location, consumed content creation date, consumed content publication date, consumed content experience level rating, and a series of consumption indices associated with users who have consumed content associated with said consumed content profile.

12. The method of claim 1 wherein said user can rate, rank and tag a user's prior consumed content to aid the recommendation engine in selecting relevant consumed content to offer to user of like content consumption habits.

13. The method of claim 1 where said user can upload, create or modify content for analysis by the recommendation engine.

14. The method of claim 13 wherein said user can rate, rank and tag said uploaded, created or modified content to aid the recommendation engine in selecting relevant consumed content to offer to user of like content consumption habits.

15. The method of claim 1 wherein a user is selected from the group consisting of person or an IP enabled computer peripheral.
